(19) United States
(12) Patent Application Publication
(10) Pub. No.: US 2016/0083270 A1
(43) Pub. Date: Mar. 24, 2016

(54) A METHOD OF DEGRADING CONTAMINANTS / POLLUTANTS FROM A MATERIAL AND STRUCTURES FOR CARRYING OUT SAID METHOD

(71) Applicant: SWANSEA UNIVERSITY, Singleton Park, Swansea (GB)

(72) Inventors: Cecile Charbonneau, Singleton Park (GB); Rachel Woods, Singleton Park (GB)

(21) Appl. No.: 14/889,584

(22) PCT Filed: Apr. 28, 2014
(86) PCT No.: PCT/GB2014/000163

§ 371 Date: Nov. 6, 2015

(30) Foreign Application Priority Data
May 7, 2013 (GB) 1308194.8

(51) Int. Cl. C02F 1/30; B01J 21/06; E04C 2/00; B01J 35/00

(52) U.S. Cl. CPC C02F 1/30; B01J 35/004; B01J 21/063; E04C 2/00; C02F 2305/10

(57) ABSTRACT

A method of removing contaminants from liquid passing over a surface by applying a photocatalyst to said surface 2, such that when a liquid passes over said surface in the presence of solar power, contaminants are degraded to less harmful compounds in said liquid. The photocatalyst is typically titanium dioxide applied as a coating on a surface such as glass or metal and can be used to degrade contaminants in effluents from industrial processes such as the textile or paper industries when liquid from those processes flows over the coating.

### FIELD OF THE INVENTION

The invention relates to a method, material and structures for degrading contaminants/pollutants from a material in contact with a photocatalytic surface and in particular but not exclusively to the removal of contaminants/pollutants from wastewater using radiation such as solar or artificial UV radiation.

### BACKGROUND OF THE INVENTION

The demand for energy has increased over the years and this has resulted in there being more research in the area of renewable energy to mitigate the effects of global warming and energy changes. There is an abundance of solar energy reaching the earth and so ways have been developed to harness and make use of that energy. Advances in this research have facilitated the development of a photoactive coating that can be applied to the treatment of contaminated water.

The areas of the world with high levels of sunlight are often those areas of the world where there may be a shortage of water for drinking and crops and so increasingly there is a need to produce potable water in those areas. Historically water has been treated by using membranes, filters or by using chemicals that kill off bacteria but in many areas of the world, people just take their chance and use the water available. This is because filters or chemicals may not be readily available or they are too costly to buy. In addition, industrial/commercial and domestic waste water, rain and flood water contain chemicals, if left untreated, may have an environmental impact if they enter the ecosystem, which is not desirable. In particular there is a need to de-colourise water that has been released from the textile industry which may contain dye contaminants which could get into the environment.

The present invention seeks to overcome the problems of the prior art by providing a water treatment system that can be stand alone or incorporated to any existing treatment plant, using an energy source such as solar energy to degrade contaminants/pollutants found in liquids such as water streams.

### SUMMARY OF THE INVENTION

According to a first aspect of the invention there is provided a method of degrading contaminants/pollutants from liquid in contact with a surface by applying a photocatalytic material to said surface such that when the liquid comes into contact with said surface in the presence of radiation, contaminants/pollutants are degraded from said liquid.

By liquid, we mean suspension, solution or colloid of any flowing material having particles or molecules that can be degraded from the liquid.

Preferably, the photocatalytic material is activated by solar or artificial UV light.

It is envisaged that the photocatalytic material is typically incorporated in a carrier material in the form of an emulsion allowing the photocatalyst to be applied to a surface.

It is envisaged that the photocatalytic material is selected from one or more of an oxide of titanium, zinc, copper, aluminum, or zirconium.

Preferably the photocatalytic material includes titanium dioxide.

It is envisaged that the titanium dioxide is AEROXIDE® TiO₂ P25.

The P25 is typically formed of titanium dioxide which includes the anatase and rutile crystallographic forms in rutile/anatase ratios ranging from 20%/80% to 30%/70%.

Preferably the titanium dioxide is a mixture of titanium dioxide P25 and titanium dioxide crystalline anatase nanoparticles. It is envisaged that there is up to 50% anatase particles.

It is preferred that the mixture of titanium dioxide P25 and titanium dioxide nanocrystalline anatase particles are in a carrier based on polyethylene glycol (PEG).

Typically a solution of 5-40% PEG(Polyethylene Glycol) in solution is used. The PEG typically has a molecular weight ranging between 1000 to 20,000.

It is envisaged that the photocatalytic material is applied as a layer to the surface and more particularly in the form of a paste that can be applied to the surface.

Preferably the layer is applied to the surface and cured.

The curing is achieved by treating the surface with near infrared radiation.

According to a second aspect of the invention there is provided a photocatalytic material that can be applied to a surface so that when a liquid comes into contact with the surface in the presence of radiation, contaminants/pollutants can be degraded by a photocatalytic reaction.

It is preferred that the radiation is in the form of solar power or UV radiation.

Preferably the photocatalytic material includes titanium dioxide.

It is envisaged that the photocatalytic material is formed of a mixture of titanium dioxide (P25) and titanium dioxide crystalline anatase nanoparticles.

Typically the photocatalytic material is in a carrier so the photocatalytic material can be applied to a surface.

It is envisaged that the photocatalytic material is provided as a paste that can be applied to a surface and cured to form a photocatalyst surface for the degradation of contaminants/pollutants from a stream flowing over said treating surface. Typically the stream flowing over the surface is an aqueous stream.

It is envisaged that the surface is glass or alternatively a metal surface such as steel.

As an alternative the photocatalytic material may be applied to a carrier sheet having a peel off backing so that the carrier sheet can be applied to a surface.

### BRIEF DESCRIPTION OF THE DRAWINGS

An embodiment of the invention will now be described by way of example only with reference to and as illustrated in the accompanying drawings in which:

FIG. 1 shows: a schematic of the deposition of titanium dioxide particles on a surface;

FIG. 2 shows: a Scanning Electron Micrograph of aTiO2 paste containing P25 with 20% crystalline anatase nanoparticles prior to sintering;

FIG. 3 shows: a Scanning Electron Micrograph (SEM) and the crystal structure of TiO2 paste containing P25 with 20% crystalline anatase nanoparticles post sintering; and

FIG. 4 shows: photocatalytic curves showing the degradation of indigo carmine using different TiO₂ mixtures in suspension.

### DETAILED Description of an Embodiment of the Invention

The treating surface is based on a photocatalytic system that can provide a self-sustaining and inexpensive reactor that can be used to degrade materials such as synthetic and biological organic pollutants that are typically found in water, such as rainwater or water that has come from a processing plant, for example water effluents from the paper or textile industries thereby making the water harmless to aquatic organisms, usable for irrigation and with adequate treatment it may even be suitable for the human consumption.

The aspects of the present invention will be described more fully hereinafter with reference to the accompanying drawings. This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations there of herein, is meant to encompass the items listed thereafter as well as, optionally, additional items.

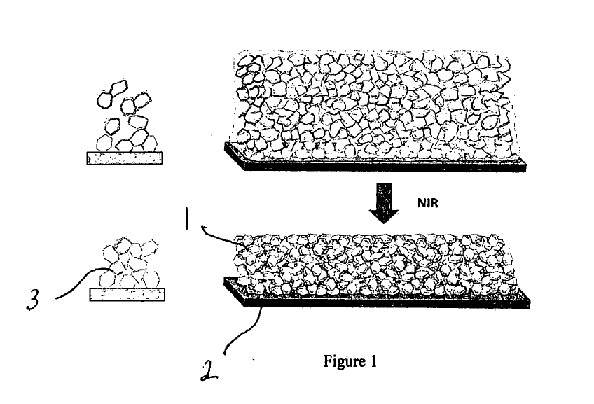

The surface that is used includes TiO₂ which is incorporated into a formulation that is preferably in the form of a paste. The definition of paste includes a mixture, slurry or dispersion. As shown in FIG. 1, wet slurry of a titanium dioxide containing paste 1 can be deposited onto a surface 2 such as glass or metal. In fact the paste can be deposited on any substrate and a particular way of laying down the paste involves roller coating, screen-printing or painting the paste on the surface. Typically, the paste is prepared by mixing TiO₂ nanopowders with a binder, such as polyethylene glycol and the mixture may be further condensed by evaporation until an appropriate viscosity and TiO₂ content has been reached. The particles form a porous mass with a large surface area.

The paste may be applied directly to a surface or it may be incorporated in a carrier material such as a clear plastic sheet with the paste on one surface and a peel off backing on the other side of the sheet. In this way, a sheet of photocatalytic material can be applied to surfaces easily and quickly. The material can be applied to windows or walls which are exposed to solar energy (from sunlight). When a liquid such as water passes over the surface, then UV radiation from the sun can break down contaminants. Typically the process involves oxidation which can result in total mineralisation of many pollutants, such as the organic pollutants found in dyes, e.g. indigo dyes. It is envisaged that the material may be a polyimide coating on steel.

The paste is typically a roller coatable or screen-printable titanium dioxide paste that may be laid down on a surface. The paste is made using known water-based formulations, and from a mixture of AEROXIDE® TiO₂ P25 and anatase and rutile crystalline varieties of titanium dioxide nanoparticles produced by aqueous-synthesis. Once applied to the surface the catalytic material is sintered using NIR radiation so that dry mesoporous titanium dioxide (or any other material that is capable of being involved in a solar or artificial UV radiation induced catalytic reaction can be stabilized onto a surface.

Production of an anatase version of the titanium dioxide involves the forced hydrolysis of variable concentrations of TiCl₄ (titanium tetrachloride) or TiCl₄.THF (titanium tetrachloride tetrahydrofuran) aqueous solutions, from 0.1 to 0.5 M, at 80 degrees centigrade for a period of 30 minutes to 2 hours at atmospheric pressure. The crystallite size of the aqueous-synthesized nc-anatase material is much smaller than commercially available materials and is typically 3-10 nm.

The aqueous synthesis process may be modified by using >0.2 M TiCl4 solutions to produce rutile nanostructured titanium dioxide particles. The rutile particles are larger and they are typically 100-500 nm in size. The anatase and rutile particles may be blended at various ratios to prepare composite pastes.

The aqueous-synthesis method is much less chemical intensive than conventional sol-gel/solvent based processes such as typically designed to synthesize anatase titanium dioxide nanoparticles with low particle size <20 nm. The use of a simple chemical reactor operated under atmospheric pressure is another advantage when compared to the use of pressure autoclaves required for the crystallization of TiO₂ products issued from sol-gel processes.

In this process, low-energy ultraviolet light is used to generate active oxygen species which oxidize and degrade toxic organic pollutants. These species are capable of generating strong oxidant radicals that can mineralize various types of organic pollutants found in aqueous streams, including textile dyes and phenols, as well as other impurities.

It is envisaged that immobilized nano-porous TiO₂ can be coated over metal sheets, glass panels or ceramic tiles.

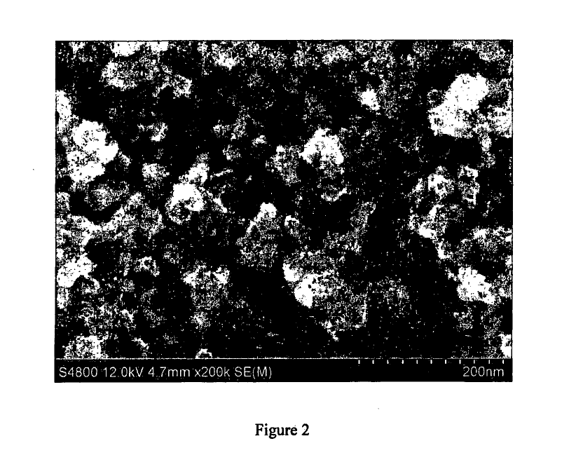

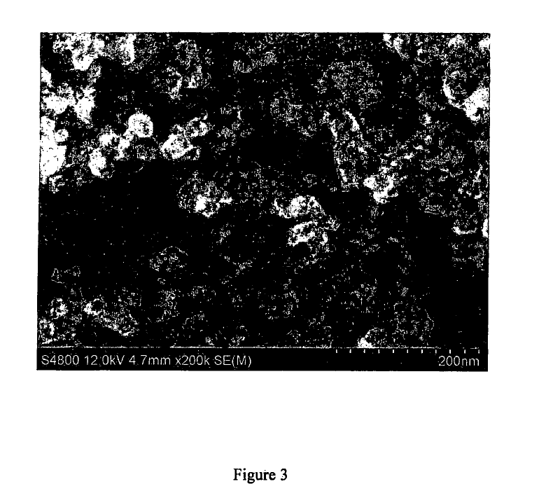

The paste can be prepared with various fractions of AEROXIDE® TiO₂ P25 and aqueous synthesized anatase (A) and rutile (R) type materials and these can also be further blended with other intermediate size TiO₂ particles to those of A and R. By adjusting the ratios of the different types of particles and sintering it is possible to produce a material with optimized surface area (photocatalytic activity), adhesion and porosity. During water treatment the smaller, crystalline anatase nanoparticles have a higher photocatalytic activity due to a greater surface area. This is observed by comparing the speed at which dye solutions are decolourised. Compared with pastes made in the same way using P25 only; the nanocrystalline anatase particles significantly increase the photocatalytic activity. The difference in the particles can be observed in FIGS. 2 and 3. In FIG. 2 the particles are shown pre-sintering, while in FIG. 3, we see particles post-sintering.

TiO₂ is as a photocatalyst that in combination with UV radiation can be used to produce immobilized mesoporous TiO₂ substrates to degrade organic contaminants/pollutants found in water such as harmful pathogens and organic compounds. The present invention has developed a new device where a mesoporous structure with adequate surface area becomes active, for example when exposed to UV solar or artificial radiation allowing a photocatalytic process to occur.

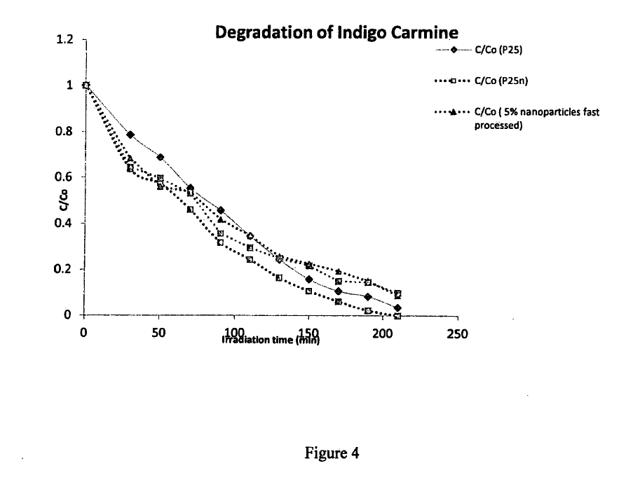

Tests were performed to study the degradation of indigo carmine, a soluble sodium salt used as a blue dye, which are shown in FIG. 4. UV/Vis spectroscopy was used to compare the photocatalytic activity of the TiO₂ pastes containing different ratios of P25 and synthesised crystalline anatase nanoparticles and different processing methods. The TiO₂ coatings immobilised on stainless steel and glass substrates were placed in a solution of indigo carmine dye. A UV light source consisting of 6.8 watt UV tubes was used to induce photocatalysis. Decolourisation of the dye was followed by observing the decrease in the absorption peak maximum of the dye at 610 nm by real time measurements using a dip-probe combined to a UV/Vis spectrometer. Complete decolourisation was achieved in under 4 hours, with the TiO₂ paste containing the nanocrystalline anatase particles significantly increasing the photocatalytic activity.

It is to be understood that the above embodiments have been provided only by way of exemplification of this invention, such as those detailed below, and that further modifications and improvements thereto, as would be apparent to persons skilled in the relevant art, are deemed to fall within the broad scope and ambit of the present invention described. Furthermore where individual embodiments are discussed, the invention is intended to cover combinations of those embodiments as well. The systems shown and described are not limited to the precise details and conditions disclosed. Method steps provided may not be limited to the order in which they are listed but may be ordered any way as to carry out the inventive process without departing from the scope of the invention. Furthermore, other substitutions, modifications, changes and omissions may be made in the design, operating conditions and arrangements of the exemplary embodiments without departing from the scope of the invention as expressed in the appended claims.

1. A method of degrading contaminants in a liquid passing over a surface by applying a photocatalyst material to said surface such that when a liquid comes into contact with said surface in the presence of radiation, contaminants are degraded in said liquid.

2. A method according to claim 1, wherein the photocatalyst material is selected from one or more of an oxide of zinc, copper, titanium, aluminium, or zirconium.

3. A method according to claim 2, wherein the photocatalyst material includes titanium dioxide.

4. A method according to claim 3, wherein the titanium dioxide is titanium dioxide P25.

5. A method according to claim 4, wherein the titanium dioxide includes anatase and rutile nanoparticle forms in a ratio of 5:1 or 4:1 or 3:1.

6. A method according to claim 3, wherein the titanium dioxide is a mixture of titanium dioxide P25 and titanium dioxide nanocrystalline anatase particles.

7. A method according to claim 6, wherein the anatase particles are present at up to 20% of the total of particles present.

8. A method according to claim 6, wherein the mixture of titanium dioxide P25 and titanium dioxide nanociystalline anatase particles are in a carrier solution based on polyethylene glycol (PEG) and/or ethyl cellulose.

9. A method according to claim 8, wherein the solution includes 10-30% of PEG solution.

10. A method according to claim 1 wherein the photocatalyst is in the form of a paste that can be applied to the surface.

11. A method according to claim 10, wherein the layer is applied to the surface and cured.

12. A method according to claim 11, wherein curing is by treating the surface with near infrared radiation.

13. A method according claim 1 wherein the radiation that is used when the liquid comes into contact with the surface is solar or UV radiation.

14. A photocatalytic material that can be applied to a surface so that when a liquid comes into contact with the surface in the presence of radiation, contaminants/pollutants can be degraded in liquid passing by a photocatalytic reaction.

15. A photocatalytic material according to claim 14, wherein the photocatalyst is selected from one or more of an oxide of zinc, copper, titanium, aluminium, or zirconium.

16. A photocatalytic material according to claim 15, wherein the photocatalyst is titanium dioxide.

17. A photocatalytic material according to claim 16, formed of a mixture of titanium dioxide (P25) nanostructured particles and titanium dioxide nanocrystalline anatase particles, which are in a carrier so the photocatalytic material can be applied to a surface.

18. A photocatalytic material according to claim 14, provided as a paste that can be applied to a surface and cured to form a photocatalyst surface for the degradation of contaminants from a liquid passing over said surface.

19. A photocatalytic material according to claim 14 wherein the photocatalytic material is applied to a carrier sheet having a peel off backing so that the carrier sheet can be applied to a surface.

20. A photocatalytic material according to claim 14 adapted to be applied to a glass or alternatively a metal surface such as steel.

21. A building element having a photocatalytic material according to any of claim 14 coated at least in part thereon.

22. A building element according to claim 21, in the form of a roof, roof panel, wall, wall panel or guttering.

23. (canceled)

24. (canceled)
